(19) United States
(12) Patent Application Publication
(10) Pub. No.: US 2007/0282695 A1
(43) Pub. Date: Dec. 6, 2007

(54) Facilitating on-line commerce

(76) Inventors: Hagai Toper, Los Angeles, CA (US); Shirel Lev, Haifa (IL)

Correspondence Address: EMPK & SHILOH, LLP, 116 John St., Suite 1201, New York, NY, 10038, US

(21) Appl. No.: 11/441,789

(22) Filed: May 26, 2006

(51) Int. Cl. G06Q 30/00

(52) U.S. Cl. 705/26

(57) ABSTRACT

Disclosed is a system and method for facilitating on-line commerce, by rendering, according to instructions, a virtual environment, optionally selected from a set of virtual environments, and also virtual object(s) within the rendered virtual environment. A virtual object may represent an item offered for sale. A transaction may be imitated by enabling selection of item(s) offered for sale and generating a transaction data based on the item(s) selected for purchase. The virtual environment(s) and virtual object(s) may be changed or substituted with different virtual environment(s) and virtual object(s), respectively, responsive to customer instruction(s). The appearance of object(s) may be toggled between 2-D and 3-D formats. A comparative data, which is associated with a given rendered object and appear, for example, as a comparison portlet, may be provided, the comparative data being associated with items of the same type which may be provided by the same or different vendors.

### FIELD OF THE DISCLOSURE

The present disclosure relates to the field of commerce. More specifically, the present disclosure relates to a virtual three-dimensional (3-D) on-line commercial environment with interactive capabilities.

### BACKGROUND

Sometimes, a customer may want to refurnish or redecorate, for example, his kitchen, living room, bedroom, bathroom, closet, hallway, workshop or dining room. For example, a customer may want to replace, or add to, a room a new piece of furniture (for example a storage furniture such as a glass-fronted display cabinet, corner cupboard, chest drawers or buffet, bed, sofa, table, chair, and so on) or an electrical appliance (for example a refrigerator, electric cooker, washing machine, entertainment center, lantern, table lamp, corner lighting, chandelier, and so on). A customer may, in addition, want to replace a door, wall paper, wood flooring, window, tiles, and so on.

Traditionally, a customer wishing to refurnish or redecorate his house may have to adopt one of several traditional commercial models. According to a first commercial model (the “face-to-face” model), the customer physically enters a shop that specializes in selling commodities of interest to him/her (for example, a shop specializing in house furniture or home appliances) and strolls through the shop(s) while s/he reviews items put there for display for potential buyers. Often, a customer adopting this commercial model may visit several shops before he can find an item which he likes. Sometimes, after purchasing an item, the customer may feel dissatisfied because the item does not fit well into the intended location or environment (for example within a living room), for example because the color, dimensions or shape do not match to the other (functional or decorative) elements within the environment surrounding the newly purchased item.

According to a second commercial model, the customer may review printed product colored catalogs (which may be put in his post box or which the customer may obtain at shops). Some catalogs depict, in three-dimensional (3-D) pictures, a collection of complimentary items that are shown in some environment. By “collection of complimentary items” is meant items offered for sale that can usually reside in the same environment (for example in the same room). An exemplary collection of complimentary items may include, for example, a living room table, armchair, vase, carpet and lamps. The latter items may be considered complimentary because they all may fit into, or intended to reside within, a living room. A list of product prices may be associated with a collection of complimentary items or a price tag may be shown graphically attached to individual items within a given collection of complimentary items. Often, companies spend a lot of money in printing high quality catalogs, for giving the catalogs an appealing appearance.

Sometimes, using product catalogs may save a customer time that otherwise would have to be spent for going from one shop to another. However, using product catalogs have several drawbacks. For example, catalogs are expensive because they have to be designed and printed in many copies to get effective. Then, the catalog copies have to be distributed, which may add an extra cost, though many catalogs may eventually remain unused. In addition, due to the relatively high costs involved in issuing catalogs, catalogs (especially high quality catalogs) are mainly used at certain times of a year, usually before holidays.

However, printed catalogs only depict fixtures; that is, they are not interactive, and even though they may depict collections of complimentary items in a three-dimensional environment for rendering a customer an environment that is realistic to some extent, the customer cannot change anything in the pictures. For example, customers cannot change the environment itself (color, shape, dimensions and location of environmental aspects, such as walls, doors, floor, ceiling and window(s)), color or location of products (for example a table or a chair) within the three-dimensional environment. In addition, the customer does not have any control on the depicted environment and items.

In recent years, and with the proliferation of the Internet, more and more items are offered for sale using a series of Internet software applications, collectively referred to as the World Wide Web, which have brought color and sound to content published on the Internet. Recent World Wide software applications, such as Flash™ and Real Player™, are capable of accessing and presenting dynamic content such as active containers (“container”—an abstract data structure in computer programming), streaming audio/video and various combinations of other multimedia. Certain applications are capable of simulating three-dimensional environments over the Internet. For example, the web site “www.worlds.com” allows a visitor to download a software application, commonly referred to as a plug-in, which works in conjunction with the visitor's web browser to simulate a three dimensional environment on the visitors screen. The parameter(s) of the environment(s) (walls, floor, and other container(s) or object(s) within the 3-D space) are produced by the web site's computer system and several visitors to the site may share and interact within a common environment.

Visitors to web sites providing three-dimensional environments, such as “www.worlds.com”, are usually assigned a virtual representative or agent, commonly referred to as an avatar. The visitor's view of the environment is from the perspective of the avatar, and the visitor navigates the three dimensional environment by directing his avatar to move within the virtual 3-D space. The visitor's view of the environment may change in relation to the avatar's change in perspective.

It would be beneficial to utilize three-dimensional environment simulation techniques for performing on-line interactive commerce, for example over the Internet.

### SUMMARY

The following embodiments and aspects thereof are described and illustrated in conjunction with systems, tools and methods, which are meant to be exemplary and illustrative, not limiting in scope. In various embodiments, one or more of the above-described problems have been reduced or eliminated, while other embodiments are directed to other advantages or improvements.

As part of the present disclosure there is disclosed a system and method for facilitating on-line commerce environment while presenting item(s) for sale in a two-dimensional (2-D) or three-dimensional (3-D) format in an interactive manner. According to some embodiments of the present disclosure the system may include a data storage array that may contain data relating to one or more virtual three-dimensional (3-D) environments (such as a side of a house with a swimming pool or yard in front of it or next to it, living room(s), bedroom(s) and the like), virtual 2-D and/or 3-D object(s) that may represent, in 2-D or 3-D format, item(s) (for example house furniture and house appliances) offered for sale (to a potential customer) by one or more vendors, and, optionally, metadata relating to these 2-D and/or 3-D object(s) and/or items. According to some embodiments an item offered for sale may be initially presented to a customer as a 2-D object but the customer may be allowed to toggle, or switch, between the initial 2-D format of the object and a 3-D format of that object (such as by clicking on the 2-D or 3-D object, whichever is currently displayed to the customer) that corresponds, or is associated with, the same item which is offered for sale.

The metadata may include prices, bargain prices, selling conditions, liability conditions, shipment offers, promotional and other types of data, such as data required for three-dimension manipulations of the environment(s) and item(s), to be displayed to a customer from different angles or perspective(s) in accordance with customer instructions. The data contained in the data storage array may be arranged in one or more categories or libraries, where a category or library may be associated with an environment, vendor or type of item(s) offered for sale.

The system may further include an environment(s) rendering module (“ERM”) adapted to render to a customer a virtual three-dimensional environment(s) and virtual 2-D and/or 3-D object(s) within the rendered environment(s) in accordance with the customer's instruction(s). In general, a customer may instruct the ERM to render for simulation “internal environment(s)” and/or “exterior environment(s)”. Internal environment(s) may include, for example, the interior space(s) of substantially any type of structure (for example room(s) in a house, building, office, factory, warehouse, and the like). External environment(s) may be any type of environment(s) other than internal environment. Unroofed garden(s) and unroofed swimming pool(s) are exemplary external environments.

The system may further include a transaction module (“TM”) adapted to initiate a transaction with one or more sources of object(s), and a communication module adapted to receive goods related data from one or more vendors, and to communicate rendered virtual three-dimensional environment(s) and object(s) to a customer based on the customer instructions.

According to some embodiments a customer may instruct the ERM to render to him a specific virtual three-dimensional environment(s) selected from a group(s) consisting of different environments. The ERM may render to the customer, with a rendered environment, virtual 2-D and/or 3-D object(s) that represent an initial collection of complimentary item(s), which are initially positioned within the rendered virtual environment. According to some aspects, the ERM may render to the customer a blank environment and the customer may composite an environment by causing an initial collection of complimentary item(s) of his choice to be displayed within the rendered environment.

The customer may see the rendered environment from the perspective viewpoint of a virtual agent or avatar traveling along a path through the rendered environment(s). Parameter(s) associated with the rendered environment(s) may be updated as a function of the agent's position. The environment's position may also change to create the perception that the environment is either traveling towards or away from the viewer's agent. An environment may either have persistence, such as a portion of the environment's background, or may be transient, moving in and out of the environment.

According to some embodiments each item(s) offered for sale has/have at least an associated tag price. Optionally, additional metadata data may be associated with one or more item(s). In some aspects, a price tag of an item(s) may be graphically seen attached to the item(s). According to some aspects a price tag of an item(s) may be initially hidden and seen graphically attached to the item(s) only after clicking the item(s) by the customer. In some aspects clicking a price tag graphically attached to an item(s) may result in displaying to the customer additional metadata, which may include predefined information, though the predefined information may vary once in a while, according to the type or category of item(s) and, in general, according to the circumstances.

According to some embodiments more than one 2-D and/or 3-D object may be associated with a common type or category of item (for example a chair). The 2-D and/or 3-D objects associated with a common type or category of item may each originate from (or otherwise be associated with) a different vendor, and, according to some embodiments, such 2-D and/or 3-D objects may be graphically displayed (or otherwise introduced) to a potential customer, in a comparative manner, responsive to instruction(s) generated and forwarded by the customer to the ERM. According to some embodiments the customer may instruct the ERM to independently change one or more traits (for example color, size, relative location, perspective angle, and so on) of virtual object(s) within a given environment(s).

According to some embodiments if a customer clicks, for example on a price tag associated with an item(s) which the customer wants to purchase, the TM may generate and forward to the customer an item(s) selection form for enabling the customer to select that item(s) for purchase. If the item(s) selected for purchase is the last selected item(s), the TM may generate and forward to the customer a general transaction list for the customer's approval. Upon approval of the transaction by the customer, the TM may generate and forward orders relevant to the respective vendors (the object(s) source(s)), and a copy thereof to the customer, optionally with a list summarizing the items purchased by the customer from all the vendors, along with associated transaction data.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. It is intended that the embodiments and figures disclosed herein are to be considered illustrative, rather than restrictive. The disclosure, however, both as to organization and method of operation, together with objects, features, and advantages thereof, may best be understood by reference to the following detailed description when read with the accompanying figures, in which:

FIG. 1 schematically illustrates an exemplary general layout and functionality of a system for facilitating on-line commerce according to an embodiment of the present disclosure;

FIG. 2 is an exemplary flow chart showing the steps of a method of on-line commerce according to an embodiment of the present disclosure;

FIG. 3 depicts an exemplary item selection form according to an embodiment of the present disclosure;

FIG. 4 depicts an exemplary general transaction form according to an embodiment of the present disclosure;

FIG. 5 depicts an exemplary virtual environment (an exemplary living room) and virtual objects in accordance with an embodiment of the present disclosure; and

FIG. 6 shows an exemplary comparative data associated with items of the same type which may be provided by the same vendor or by different vendors.

It will be appreciated that for simplicity and clarity of illustration, elements shown in the figures have not necessarily been drawn to scale. For example, the dimensions of some of the elements may be exaggerated relative to other elements for clarity. Also, at times singular or plural (or options between singular and plural) may be described, however, notations or descriptions of singular include, or is to be construed as, plural, and plural include, or is to be construed as singular where possible or appropriate.

### DETAILED DESCRIPTION

In the following detailed description, numerous specific details are set forth in order to provide a thorough understanding of the disclosure. However, it will be understood by those skilled in the art that the present disclosure may be practiced without these specific details. In other instances, well-known methods, procedures, components and circuits have not been described in detail so as not to obscure the present disclosure.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present disclosure may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present disclosure are not described with reference to any particular programming language. It will be appreciated that a variety of programming languages may be used to implement the teachings of the disclosure s as described herein.

As part of the present disclosure, a virtual three-dimensional environment is rendered by an environment rendering module. Data memory storage may contain one or more display parameter(s) representing at least some portion of content to be presented to a user or viewer. The data memory storage may also contain one or more associated functions which may be initiated by a user's interaction with the environment. One or more display parameter(s) may include characteristics such as position, size, shape, color, texture, surface appearance or covering, and movement. Any one or more object(s) may have a fixed position or may move in and out of the environment. Any one or more object(s) may have an associated message(s) or picture(s) or other information which may be mapped onto a portion of the surface of the object(s).

The viewer's view of the environment may be produced by a view production module producing a view from the perspective of a virtual agent passing through the environment. As the virtual agent travels through the environment, the viewer's perspective of the environment and of containers contained therein may change accordingly. Furthermore, display parameter(s) and associated function(s) of one or more of the container(s) or object(s) within the environment may change or be updated by an update module. The update module may update the parameter(s) and/or associated function(s) in relation to a change in the viewer's perspective. That is, associated function(s) and display parameter(s) such as shape, color or mapped pictures, of one or more of the container(s) or object(s) may change as the virtual agent's position in the environment changes. The associated function(s) and display parameter(s) may be updated with pre-selected parameter(s) stored on one or more database(s), or may change according to input received over a distributed data network.

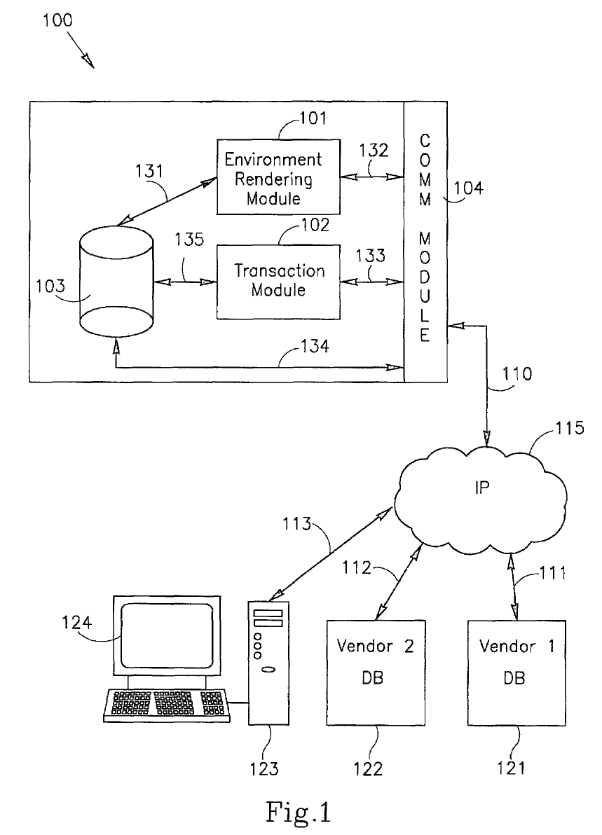

Referring now to FIG. 1, an on-line commerce rendering system (generally shown at 100) according to some embodiments of the present disclosure is shown and described. On-line commerce environment rendering system 100 may include one or more environment(s) rendering modules (ERMs) such as ERM 101, transaction module(s) 102, a data storage array(s) 103 and communication module(s) 104. On-line commerce environment rendering system 100, exemplary vendors 121 and 122, and exemplary customer 123 are shown functionally coupled (shown at 111, 112, 113 and 114, respectively) to packet switched network 115, over which they may bi-directionally communicate with on-line commerce environment rendering system 100.

Environment(s) rendering module (ERM) 101 may be adapted to render to customer 123 a virtual commerce environment in accordance with instructions from customer 123. ERM 101 may be also adapted to render one or more virtual 2-D and/or 3-D object(s) within one or more rendered environment(s), wherein data associated with (2-D and/or 3-D) virtual object(s) (for example price, payment options, credit conditions, and so on) may be provided by a respective source of the object, which may be (though this is not necessarily so) the vendor of the associated item(s) being offered for sale. Vendors 121 and 122 may each be a source of one or more 2-D and/or 3-D virtual object(s) that may represent respective items offered by vendors 121 and 122 for sale. For example, vendor 121 may specialize in selling tables and chairs and vendor 122 may specialize in selling lamps and carpets. A corresponding virtual two or three-dimensional object may be generated to represent a single item offered for sale (for example a table, chair or lamp). According to some embodiments vendors 121 and 122 may generate the virtual object(s) and forward them to on-line commerce rendering system 100, over switched packer network 115 and through communication module 104. Communication module 104 may then forward (shown at 134) them to data storage array 103 for storage. Alternatively, vendors 121 and 122 may generate and forward to on-line commerce rendering system 100 only metadata associated with the object(s), from which on-line commerce rendering system 100 can generate the virtual object(s) and store (shown at 131) at one or more data storage array(s) 103. One or more object(s) of a vendor may be eventually requested by (rendered to) one customer such as customer 123 but not by other customers, or an object(s) may not be requested at all by any customer.

According to some embodiments an item offered for sale (for example a table) may be initially presented to customer 123 (on his/her computer screen 124) as a 2-D object, but customer 123 may be allowed to forward (shown at 113) to ERM 101 a toggle instruction, causing ERM 101 to toggle/switch between, or substitute, the initial 2-D format of the object (the table, in this example) and/with a corresponding 3-D format of that table (such as by clicking on the 2-D or 3-D object, whichever is currently displayed to the customer) that corresponds, or is associated with, the same type (tables in this example) of item which is offered for sale.

In general, transaction module (TM) 102 may be adapted to imitate a transaction with one or more object(s) source(s) such as vendors 121 and 122, where “imitate” means providing by TM 102 for filling-in (automatically where appropriate and, wherever required, by a customer) a computer-generated transaction-oriented form with buyer(s), seller(s) and selling particulars in a way similar to the “face-to-face” commerce that is usually done in accordance with the first traditional commerce model described hereinbefore.

Data storage array 103 may contain data relating to one or more virtual three-dimensional environment(s), for example an exterior side of a house shown with a swimming pool or yard in front of it or next to it, living room(s), bedroom(s) and the like. Data storage array 103 may further contain data relating to one or more virtual (two or three-dimensional) object(s) that may represent item(s) offered for sale (for example home furniture and home appliances) by one or more vendor(s), and, in addition, metadata relating to item(s) offered for sale. Metadata may include prices, bargain prices, selling conditions, liability conditions, shipment proposals, promotional and other types of data. The data contained in data storage array(s) 103 may be arranged in one or more categories or libraries, where a category or library may be associated with an environment, vendor or type of item(s) offered for sale.

Data storage array 103 may contain one or more display parameter(s) required for manipulation of environment(s) and object(s) (representative of items) to be displayed to the customer from different angles or perspective(s) in accordance with the customer instruction(s). Data storage array 103 may also contain one or more function(s) which may be initiated by a user's interaction with the environment(s) currently presented to him for enabling the manipulation of the environment(s) and object(s). Display parameter(s), which may represent at least some portion of content to be presented to the customer, may include characteristics such as position(s), size(s), shape(s), color(s), texture(s), surface appearance or covering, orientation and movement. Every time customer 123 manipulates or modifies a given virtual environment(s) or object(s), customer 123 may forward (shown at 132) a corresponding data to ERM 101, which, in turn, may store (shown at 131) them, and/or associated metadata, in data storage array(s) 103.

In general, a rendering module such as ERM 101 may operate in conjunction with a computer processor to compile a data set or array, or set of arrays of data, in a data storage array such as data storage array 103, which data may represent a three dimensional environment. Conversion or mapping of a data set representing a virtual three-dimensional environment into a two-dimensional image is well known. Commercially available software application(s) (for example MatLab) that enable a virtual environment and a virtual object to be visually manipulated may be used as part of the present disclosure. A virtual object(s) may be projected into a virtual environment(s), where the term “projected” generally means a data set representing the virtual object added to the data set representing the virtual environment.

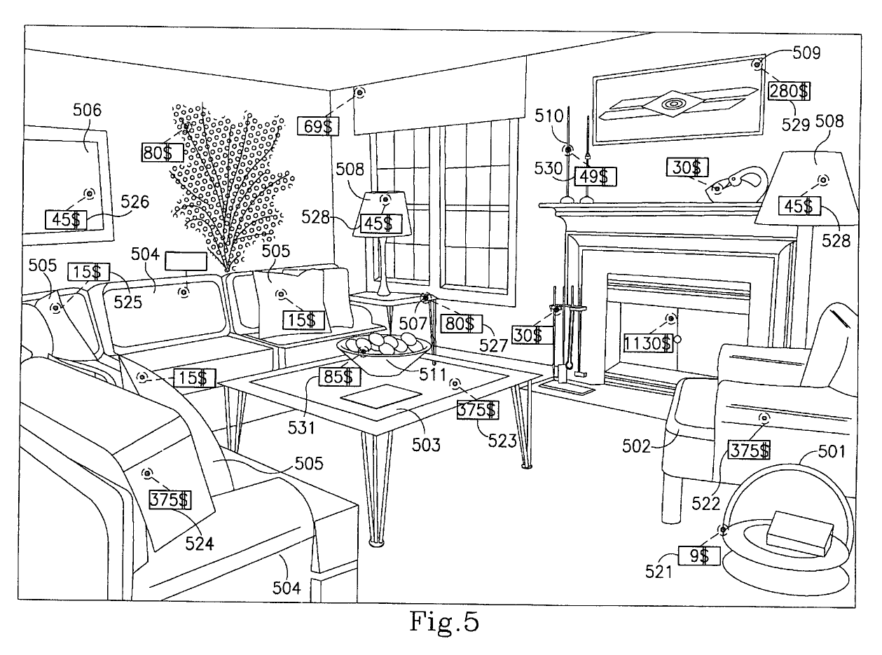

In general, a customer (such as customer 123 in FIG. 1) may instruct an ERM (for example ERM 101 of FIG. 1) to render for simulation “internal environment(s)” and “exterior environment(s)”. Internal environment(s) may include, for example, the interior space(s) of substantially any type of structure (for example room(s) in a house or building). An internal environment (an exemplary living room) is exemplified in FIG. 5. External environment(s) may be any type of environment(s) other than internal. An open yard, unroofed garden(s) and unroofed swimming pool(s) are examples for external environments.

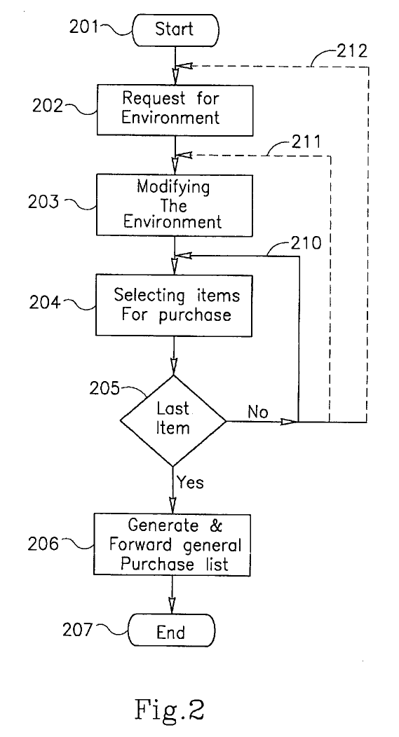

Referring now to FIG. 2, steps of a method of on-line commerce according to some embodiments of the present disclosure is shown and described. FIG. 2 will be described in association with FIG. 1. As a start (shown at 201), customer 123 may remotely access (shown at 113 and 110 in FIG. 1) an on-line commerce rendering system 100, which may then display to customer 123 a list of virtual environments available from data storage array 103 from which customer 123 may select a virtual environment of his, or her, choice. Alternatively, ERM 101 may fetch (shown at 131 in FIG. 1) from data storage array 103 and display, on computer screen 124 of customer 123, available virtual environments in the form of distinct icons, or in any other suitable form or way. Customer 123 may then request (shown at step 202 in FIG. 2) a specific virtual three-dimensional environment to be displayed on his, or her, computer screen 124. The request for specific virtual three-dimensional environment may reach ERM 101 (shown at 132) over packet switched network 115 and through communication module 104. Responsive to the request being received (shown at 132) at ERM 101, ERM 101 may fetch (shown at 131) from data storage array 103 and render (shown at 132) the virtual environment requested by customer 123, with an initial collection of complimentary items. For example, if the virtual environment requested by customer is a bathroom, a well-equipped bathroom will be displayed to customer 123. For example, a well-equipped bathroom may include, for example, floor and walls tiles, a bathtub, diverter valve, spray head, single-handle faucet, fixed and portable shower head, cabinet, soap dish, sink, tumbler holder, toilet seat, toilet bowl, toilet tank, tissue holder, towel bar and so on. According to some embodiments of the present disclosure, customer 123 may remove item(s) offered to sale and currently displayed to him, select and add additional item(s) to the virtual environment or substitute (remove and add) an item(s) with an item(s) of the same category or type. For example, customer 123 may substitute a currently displayed chair with another, or lamp with another, and so on.

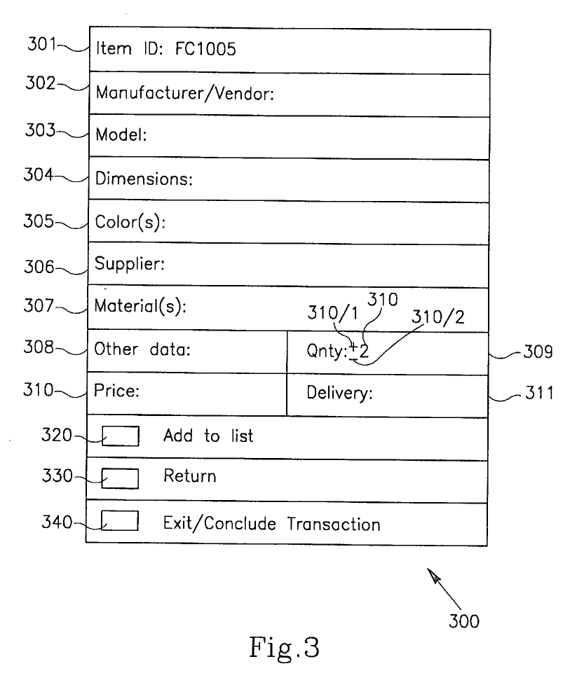

At step 203, customer 123 may modify (redecorate) the virtual bathroom (for example) according to his preferences, to create a bathroom of his choice. For example, customer 123 may send to ERM 101 an instruction to change the type, color, design, size or shape of all the wall tiles, or to do so only in respect of a few tiles. Customer 123 may also send to ERM 101 an instruction to change any desired attribute (for example the type and/or color) of the bathtub and/or cabinet, move the toilet and/or cabinet to a different location, and so on. ERM 101 may respond to each instruction from customer 123 by seeking (shown at 131) in data storage array(s) 103 for the corresponding object(s) and associated metadata, recalculating insertion parameter(s) for each requested object(s) and refreshing the virtual environment(s) image while factoring in newly requested object(s). Then, ERM 101 may forward (shown at 132 in FIG. 1) the refreshed virtual environment image(s) to communication module 104 and communication module 104 may forward (shown at 110 in FIG. 1) it to customer 123, over packet switched network 115. A price tag may be graphically attached, with or without additional data, to each object(s) that represents an item(s). Modifying the virtual environment(s) by a customer such as customer 123 may be beneficial for the customer because, this way, the customer may simulate real rooms in his house which he wants to redecorate or refurnish. For example, if a customer such as customer 123 wants to buy a new set of chairs for his dining room, the customer may modify a virtual dining room that may be initially displayed to him, or her, in accordance with his/her instructions to ERM 101, to simulate his/her, own dining room. Then, the customer may instruct ERM 101 to display to him/her optional virtual object(s) of different types of chairs from which the customer may choose a first chair object. The customer may then instruct ERM 101 to duplicate the first chair object as many times as he/she wants and to set the chair object(s) (for example six chair objects) around the virtual table in a realistic manner. The customer may further instruct ERM 101 to change the number, type or color of the chair object(s), and the special orientation of the table and chairs within the virtual environment (a virtual dining room in this example). The customer may choose a table object, for example, which is identical or similar to the table he/she has in his/her real dining room, so that he/she may get an impression of how a new set of chairs may fit into his/her dining room. If, after trying one or more types of chairs, the customer likes a certain chair, the customer may initiate a transaction, for example by selecting (shown at step 204) the object of (the object associated with) that chair, and in general, the customer may initiate a transaction by selecting the object(s) associated with the item(s) that he/she wants to buy. Selection of item(s) for purchase by a customer may be implemented, for example, by clicking on the corresponding object(s) or on the price tag graphically attached to the item(s) (for example a chair) he/she wants to purchase. Clicking (by the customer) on an object, or on a price tag associated with an object, may cause a corresponding instruction to be generated by the customer and forwarded to ERM 101, which will cause ERM 101 to display to the customer a computer-generated item(s) selection form such as computer-generated item(s) selection form 300 of FIG. 3.

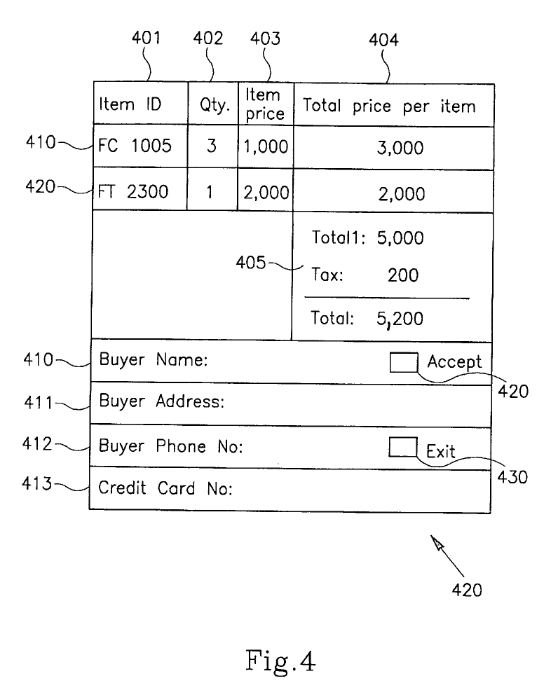

If an item selected (for example by customer 123) for purchase according to step 104 is not the last item (shown as No at 205) customer 123 wants to purchase, customer 123 may select (shown at 210) for purchase an additional item within the virtual environment currently displayed to customer 123 by ERM 101. Alternatively or additionally, customer 123 may further modify (shown at 211) the virtual environment currently displayed to him/her by ERM 101, for example by instructing ERM 101 to add new item(s) object(s) to, or to substitute item(s) object(s) already existing within, the virtual environment currently displayed to customer 123 by ERM 101. Alternatively or additionally, customer 123 may request shown at 212) from (by forwarding a corresponding instruction to) ERM 101 to substitute a virtual environment currently displayed to him/her with a different virtual environment, for example with a virtual living room. If an item selected for purchase by a customer in accordance with step 204 is the last (shown as Yes at 205) item the customer wants to purchase, the customer may, at step 206, forward (shown at 133 in FIG. 1) an instruction to TM 102 to generate a general purchase list, such as general purchase list 400 of FIG. 4, with details of the transaction. The customer may then conclude (shown at 207) the transaction in a way exemplified in connection with general purchase list 400 of FIG. 4.

Referring now to FIG. 3, an exemplary computer-generated item(s) selection form (generally shown at 300) is shown and described according to some embodiments of the present disclosure. According to some embodiments of the present disclosure one computer-generated item(s) selection form, such as item(s) selection form 300, may reflect a single acquisition; that is, such a selection form may be used for purchasing a single item, where two or more identical items may be associated, in accordance with these embodiments, with their own selection form. According to some other embodiments of the present disclosure one computer-generated item(s) selection form, such as selection form 300, may reflect the accumulation of multiple purchases of identical item(s).

Exemplary item(s) selection form 300 may include, for example, the item's ID (“Item ID”, shown at 301) assigned by the source (for example) of the item(s). For example, assuming that the item(s) currently selected by the customer for purchase and associated with item(s) selection form 300 is a specific chair, an exemplary item ID FC1005 may be assigned to this chair, where the exemplary letter ‘F’ may, for example, indicate that the item (a chair in this example) belongs to the furniture main department and the exemplary letter ‘C’ may, for example, indicate that the chair (in this example) belongs to the chairs sub-department. The exemplary number ‘1005’ may designate, for example, the item's model. Item(s) selection form 300 may further include the item's manufacturer or vendor (shown at 302), model of the item (shown at 303), relevant dimension(s) of the selected item(s) (shown at 304), color(s) of the item(s) (shown at 305), supplier of the item(s) (shown at 306), materials the item(s) is made of (shown at 307), other relevant data (shown at 308), total quantity of items of the same type (shown at 309) already selected by the customer for purchase. For example, if the customer already selected for purchase two items that are identical to (having the same item ID as) the currently selected item(s) (item identification FC1005 in this example, shown at 301), the number ‘2’ (shown at 310) will appear in Quantity 309. Optionally, the customer may add identical item(s) by clicking on ‘+’ (shown at 310/1) or deduct identical item(s) by clicking on ‘−’ (shown at 310/2). Of course, other methods may be used to add and deduct item(s) to Quantity 309. Item(s) selection form 300 may further include the item's individual price (“Price”, shown at 310) and delivery details (shown at 311). Of course, the structure and/or appearance of the item(s) selection form may be different from the structure and appearance of exemplary item(s) selection form 300.

If the customer decides to purchase the item he/she currently selected, he/she may check the “Add to List” box 320 to add the currently selected item to a general purchase list which may be identical or similar to general purchase list 400 of FIG. 4. The customer may return to the virtual environment, for selecting additional items, by checking the “Return” box (shown at 330), or conclude the transaction by checking the “Exit/Conclude Transaction” box 340. If the customer regrets (he/she does not want to purchase the currently selected item), he/she may uncheck “Add to List” box 320 and, thereafter, check “Return” 330 box or “Exit/Conclude Transaction” box 340.

Item(s) selection form 300 may be generated and displayed to a customer (such as customer 123 in FIG. 1) by transaction module (TM) 102 of FIG. 1 in response to the customer clicking on a price tag, for example. In addition, TM 102 may keep track of the customer instructions by identifying the checked boxes in item(s) selection forms such as item(s) selection form 300, and accordingly storing (shown at 135) in data storage array 103 an updated transaction data associated with the customer.

Referring now to FIG. 4, an exemplary general purchase list (generally shown at 400) is shown and described in accordance with an embodiment of the present disclosure. Responsive to a customer clicking on the “Exit/Conclude Transaction” box, TM 102 of FIG. 1 may gather (shown at 135) the updated transaction data associated with the customer and, among other things, calculate accumulating items quantities and associated prices, and forward (shown at 133) the resulting data to the associated customer in the form of a general purchase list, which may be identical or similar to general purchase list 400.

General purchase list 400 may include several fields such as “Item ID” 401, “Quantity” 402, “Item's Price” 403, “Total Price per Item” 404 and “Total” 405 which presents the total transaction cost. General purchase list 400 refers to two items, whose Item IDs are FC1005 (shown at 410) and FC1005 (shown at 420), which the customer wants to buy. Part of general purchase list 400 may include buyers' oriented fields such as “Buyer Name” (shown at 410), “Buyer Address” (shown at 411), “Buyer Phone No.” (shown at 412) and “Credit Card No.” (shown at 413). The customer may confirm his order (the transaction) by checking “Accept” bob 420, or s/he may abort the process by clicking on “Exit” box 430. Of course, general purchase list 400 may have a different appearance or include additional fields for accommodating details relating to the item(s) provider(s), delivery conditions and so on.

Referring now to FIG. 5, a portion of an exemplary virtual living room is depicted and described. Among other things, the portion of the exemplary virtual living room is shown including a collection of items (virtual object(s)) which are offered for sale. The exemplary collection of items includes magazine basket 501, armchair 502, table 503, sofa set 504, decorative pillow 505, picture 506, stand 507 for lamp 508, picture 509, candle holders set 510 and ornamental vessel 511.

Each one of the items offered to sale may have a price tag that is graphically attached to, or associated with, the respective items. For example, to magazine basket 501 is attached price tag 521 (US$9, in this example), to armchair 502 is attached price tag 522 (US$375, in this example), to table 503 is attached price tag 523 (US$375, in this example), to sofa set 504 is attached price tag 524 (US$375, in this example), to decorative pillow 505 is attached price tag 525 (US$15, in this example), to picture 506 is attached price tag 526 (US$45, in this example), to stand 507 is attached price tag 527 (US$80, in this example), to lamp 508 is attached price tag 528 (US$45, in this example), to picture 509 is attached price tag 529 (US$280, in this example), to candle holders set 510 is attached price tag 530 (US$49, in this example) and to ornamental vessel 511 is attached price tag 531 (US$85, in this example).

As is described earlier, ERM 101 of FIG. 1 may enable a customer (such as customer 123) to change or modify the virtual environment(s) and the objects composition. For example, the customer may move or hide magazine basket 501 so that s/he can have a better perception of armchair 502. The customer may change the color of armchair 502 from one color to another, provided that armchair 502 is available, or can be ordered, in these colors.

In addition, ERM 101 of FIG. 1 may enable the customer to rotate the virtual environment while each virtual item object maintains its special orientation relative to the virtual environment and to the other virtual object(s). This way, if the customer is particularly interested in sofa set 504, the customer may instruct ERM 101 to rotate the virtual environment such that s/he can view sofa set 504 from different angles. In addition, the customer may remove (the object of) table 503 in order to better view sofa set 504. If the customer is interested in a table but he dislikes table 503, ERM 101 may enable s/he to substitute table 503 with a different table. Substituting an item (for example table 503) with another item of the same type, category, group or department, may be implemented by the customer by right-clicking on the item intended to be substituted, which may result in displaying to the customer a list of other selectable items from which the customer may select an item.

Clicking (as part of step 204 of FIG. 2) on an object (for example on table 503) or on a price tag associated with an object (for example clicking on price tag 523 associated with table 503) may cause a corresponding instruction to be generated and forwarded to ERM 101. The customer's instruction forwarded to ERM 101 may cause ERM 101 to display to the customer a computer-generated item selection form such as computer-generated item selection form 300 of FIG. 3. The customer may add, for example, table 503 (or, if table 503 is disliked by the customer, a different table), to the list of items s/he wants to buy, by checking a box such as “Add to List” box 320 of FIG. 3. The customer may likewise add additional items, for example, magazine basket 501 and one of lamps 528, to the purchase list and, when the customer reaches the last item s/he wants to buy, s/he may click on a box such as “Exit/Conclude Transaction” box 340 of FIG. 3, whereby to cause ERM 101 to generate and display to the customer a general purchase list such as general purchase list 400 of FIG. 4. If the customer is satisfied with his/her selection, s/he may conclude the transaction by clicking, for example on “Accept” box 420 of general purchase list 400 of FIG. 4.

An instruction issued by a customer for ERM 101 may be executed or initiated by ERM 101 when the customer interacts with an item object, price tag associated with an item object or with a computer-generated form (item selection form 300 and general transaction list 400, for example) presented to him by ERM 101. Interaction with an item object, price tag associated with an item object or with a computer-generated form may occur through the use of a mouse pointer, a keyboard, or any other input device.

According to some embodiments ERM 101 or TM 102 of FIG. 1 may be adapted also to introduce to a customer a list of professional people associated with items offered to sale. For example, if a customer adds to the rendered environment, say, a lamp, an active mark (an indicia) may appear next, or in proximity to, the lamp and, upon clicking (by the customer) on the active mark, a list of electricians may be introduced to the customer, in accordance with the customer's residence area. Then, the customer may select from the list one or more electricians, for installing the lamp in the intended room/location. The customer may send to a printer the rendered room with the rendered items, including the lamp, for showing to the electrician the lamp's desired installation location. According to another example, clicking (by a customer) on an active mark associated with, say, a toilet bowl will cause ERM 101 or TM 102 of FIG. 1 to introduce to the customer a list of plumbers, from which the customer may select a plumber to install the bought toilet bowl. Items may be associated with corresponding or relevant professional people by using an electronic telephone directory (such as the Yellow Pages or similar telephone directory) that lists businesses, services, or products. ERM 101 (or TM 102) of FIG. 1 may be adapted to retrieve and introduce to a customer a list of professional people relevant to, or associated with, a clicked active mark and to the residence area of the customer (as entered, for example, in the “Buyer Address” field 411 in FIG. 4. Alternatively, ERM 101 (or TM 102) of FIG. 1 may be adapted to identify the computer to which environment and object(s) are rendered, and to associate the computer's identification details to the customer's residence.

According to some embodiments advertisements ERM 101 (or TM 102) of FIG. 1 may be adapted to graphically add relevant advertisement(s) to rendered items. For example, regarding internal environment(s), if walls of/in a room (for example) are virtually shown painted, advertisement(s) of the associated paint company may appear on painted wall(s). Regarding external environment(s), if a lawn (for example) is virtually shown in front of a house, advertisement(s) of the lawn may appear on/next the lawn. If flowers are virtually shown as part of the lawn, nearby or elsewhere, flowers-related advertisement(s) may appear next to flowers, and so on. Some of the advertisements may be in the form of video clips and other advertisement(s) may be stationary.

In addition, items may include sewer/water pipes/ducts, drainage system, air-condition system, electricity system and so on, all of which may be part of (internal and/or external) rendered environment. A system such as the system shown in FIG. 1 may be used, without major modifications (if at all) not only to facilitate on-line commerce activity but also to allow architects to design and decorate an environment, whether it is its interior or exterior part that needs to be designed/decorated.

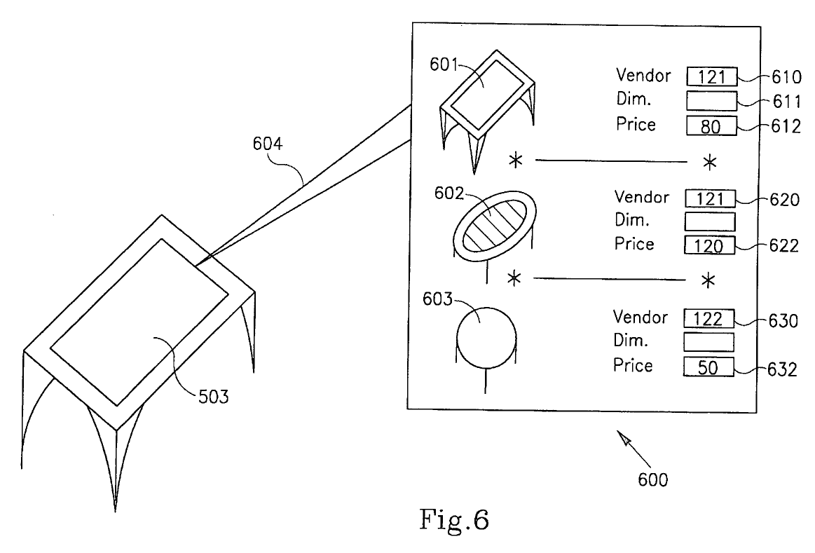

Referring now to FIG. 6, an exemplary comparison portlet (generally shown at 600) is described in association with FIG. 5. Exemplary table 503 of FIG. 5 is shown isolated in FIG. 6 for the sake of simplicity. Comparison portlet 600 is shown including, according to this example, three, possibly different, objects (shown at 601, 602 and 603) of the same item type/category (tables in this example). Each one of objects 601 through 603 may originate from, or be associated with, a different vendor and, as exemplified in FIG. 6, objects 601 through 603 are shown graphically displayed to a customer (such as customer 123 in FIG. 1) in a comparative manner, responsive to instruction(s) that customer 123 forwarded (shown at 113, 110 and 132 in FIG. 1) to ERM 101. That is, after a customer, such as customer 123 in FIG. 1, forwards instruction(s), for example by right-clicking on table 503 of FIG. 5, comparison portlet 600 may pop-up (for example on computer screen 124, in FIG. 1), which is associated with (shown at 604) (the clicked) table 505. The comparative data contained in comparison portlet 600 may include for each object 601 through 603, for example, the vendor's name (shown at 610 for object 601), general dimensions of the item (shown at 611 for object 601), and the item's price (shown at 612 for object 601). According to exemplary comparison portlet 600 the table appearing as object 601 may be provided by vendor 121 (shown at 610 and also in FIG. 1) for US$80 (shown at 612), the table appearing as object 602 may also be provided by vendor 121 (shown at 620 and also in FIG. 1) for US$120 (shown at 622), and the table appearing as object 603 may be provided by another vendor (vendor 122, shown at 610 and also in FIG. 1) for US$50 (shown at 632). Either ERM 101 or TM 134 may generate comparison portlet 600. Alternatively, ERM 101 may generate the object(s) (objects 601 through 603, for example) and the relevant field(s) (fields 610, 611, 612, and so on) in comparison portlet 600, but TM 134 may generate and display the data content in the fields (610, 611, 612, and so on).

Of course, comparative data associated with items of the same type/category (but provided by the same or different vendors) may be conveniently presented to a customer in other ways, formats or arrangements. In addition, comparative data may include different, other or additional informative data relevant for a potential transaction.

As was variously explained earlier, rendered object(s) may be independently visualized to a potential customer, meaning that although an initial set of objects may be presented to a customer in accordance with a rendered environment, the customer may still have an option to substitute selected object(s) with other (like and/or unlike) objects. However, according to the present disclosure dependent objects may also be visualized to a customer, a feature called hereinafter as next-level object(s). A next-level object is an object (of an item offered for sale) that is related to, or a part of, or associated with or accompanies a base (or first-level) object. Exemplary base objects are a glass-fronted display cabinet, a corner display cabinet, sideboard buffet, and so on. In principle, a base object is an object of an item that can hold or contain other type(s) of item(s). If, for example, a glass-fronted display cabinet (which is, in this example, a base object) is currently displayed to a customer, the customer may trigger (for example by clicking on the glass-fronted display cabinet object) the displaying of a single item or set(s) of items that are usually intended to be stored in a glass-fronted display cabinet—for example glassware (such as champagne glasses, water goblet(s), beer mugs, and so on), and/or dinnerware (such as dinner plate(s), salad plate(s), bread plate(s), butter plate(s), and so on), and so on. Regarding the exemplary glass-fronted display cabinet, the mentioned glassware and dinnerware are only exemplary next-level objects that (by being next-level objects) may be displayed to a customer only in relation to their base object(s)—in this example to the glass-fronted display cabinet—but not as independent (unrelated) objects.

Another example for a base object is a drawer in a sideboard buffet, for example. If a drawer is intended, or designed, to potentially contain silverware, the drawer may be regarded as a base object, whereas knifes (such as butter knife(s), cheese knife(s), fish knife(s), steak knife(s), dinner knife(s), and the like), forks (such as salad fork(s), dessert fork(s), dinner fork(s), fish fork(s), and so on) and spoons (such as soup spoon(s), coffee spoon(s), sugar spoon(s), teaspoon(s), and so on) may be regarded as next-level objects. Another example for base object is a bathroom and exemplary next-level objects (accessories related to bathrooms) are toilet paper, toilet paper holder(s), soap(s), soap holder(s) and so on.

While certain features of the disclosure have been illustrated and described herein, many modifications, substitutions, changes, and equivalents will now occur to those skilled in the art. It is, therefore, to be understood that the appended claims are intended to cover all such modifications and changes as fall within the true spirit of the disclosure.

What is claimed is:

1. A system for facilitating on-line commerce, comprising:
a rendering module adapted to render a virtual environment and virtual object(s) within said virtual environment in accordance with instructions, wherein data associated with virtual objects is provided by a respective source of the object(s).

2. The system according to claim 1, further comprising a transaction module adapted to imitate a transaction with one or more sources.

3. The system according to claim 1, wherein virtual objects represent items offered for sale and the respective sources of the objects are the vendors of said items.

4. The system according to claim 3, wherein the transaction module imitates a transaction by enabling a customer to select for purchase one or more items in a rendered environment and generating a transaction data based on the selection.

5. The system according to claim 3, wherein the rendered virtual environment and rendered virtual objects are changeable and replaceable.

6. The system according to claim 1, wherein the virtual environment is an internal environment.

7. The system according to claim 1, wherein the virtual environment is an external environment.

8. The system according to claim 1, wherein instruction(s) cause a 2-D format object to appear in 3-D format.

9. The system according to claim 1, wherein instruction(s) cause comparative data associated with an object to be presented.

10. The system according to claim 9, wherein the comparative data is presented as a comparison portlet.

11. The system according to claim 1, wherein the rendering module is further adapted to introduce a list of professional people associated with item(s) offered for sale.

12. The system according to claim 11, wherein the introduction is triggered by clicking an active mark which appears next, or in proximity to, item(s).

13. The system according to claim 11, wherein the rendering module is further adapted to generate the list in association with a customer's residence.

14. The system according to claim 13, wherein the rendering module identifies the customer's residence based on the computer's identification details.

15. The system according to claim 1, wherein virtual objects are associated with the design or decoration of a virtual environment.

16. The system according to claim 1, wherein the rendering module is further adapted to render next-level object(s) in association with currently displayed base object(s).

17. A method for facilitating on-line commerce, comprising:
rendering a virtual environment and virtual objects within the environment in accordance with instructions, wherein data associated with virtual objects is provided by a respective source of the objects; and
imitating a transaction with one or more sources.

18. The method according to claim 17, wherein virtual objects represent items offered for sale and the respective sources of the objects are the vendors of said items.

19. The method according to claim 18, wherein imitating a transaction comprises:
selecting for purchase one or more objects in a rendered environment associated with items offered for sale; and
generation of a transaction data based on the objects selection.

20. The method according to claim 17, wherein the virtual environment is an internal environment.

21. The method according to claim 17, wherein the virtual environment is an external environment.

22. The method according to claim 17, wherein instruction(s) cause a 2-D format object to appear in 3-D format.

23. The method according to claim 17, wherein instruction(s) cause comparative data associated with an object to be presented.

24. The method according to claim 23, wherein the comparative data is presented as a comparison portlet.

25. The method according to claim 17, further comprising rendering next-level object(s) in association with currently displayed base object(s).
